(19) United States
(12) Patent Application Publication
(10) Pub. No.: US 2009/0201674 A1
(43) Pub. Date: Aug. 13, 2009

(54) Flashlight Device with Task Light

(76) Inventors: Jeremy B. Ross, Monticello, IL (US); Gavin A. Steele, White Heath, IL (US)

Correspondence Address: ANDREWS & KURTH, L.L.P., 600 TRAVIS, SUITE 4200, HOUSTON, TX, 77002, US

(21) Appl. No.: 12/364,308

(22) Filed: Feb. 2, 2009

Related U.S. Application Data
(60) Provisional application No. 61/025,179, filed on Jan. 31, 2008.

(51) Int. Cl. F21L 4/00

(52) U.S. Cl. 362/191

(57) ABSTRACT

A preferred embodiment of the invention is a hand-mountable flashlight which provides hands-free capability by eliminating the need to grasp the device in order to retain it and independently direct a plurality of light sources. These light sources are ergonomically situated to provide multi-directional lighting when the light is mounted on the hand. A first or primary light source produces a more focused and intense light emission as compared to a second light source referred to as the task light. The placement, brightness and beam characteristics of the primary light source provide adequate illumination at distances up to and exceeding 20 feet in a dark environment. The primary light source is designed to provide forward illumination during navigation and clear target identification when the flashlight is used in conjunction with weapons such as a pistol or other firearms. The placement, brightness, and beam characteristics of the task light preferably provide a diffused or less intense light source as compared to the primary light source. The task light is ideal for illuminating objects being held or manipulated by the user or areas that are in proximity to the user's hands. Such objects might include photo identification, hand tools, keyboards, locks and keys, control panels, etc.

### CROSS-REFERENCE TO RELATED APPLICATIONS

This application claims priority from U.S. Provisional Application Ser. No. 61/025,179, filed Jan. 31, 2008. This application is related to co-pending U.S. application Ser. No. 11/931,233, filed Oct. 31, 2007. Applicant incorporates by reference herein Application Ser. No. 61/025,179.

### BACKGROUND OF THE INVENTION

1. Field of the Invention

The present invention relates generally to flashlights and methods of using same, and is adapted for convenient use in conjunction with other hand-held implements, such as firearms, or in conjunction with activities requiring the use of a user's hands. The present invention is also adapted for multi-directional lighting when the flashlight is mounted on the user's hand.

2. Description of the Related Art

By way of background, a number of flashlights or flashlight holders are known that are designed for use in combat or self-defense situations. Several of these holders and flashlights are disclosed, for example, in U.S. Pat. Nos. 6,270,231; 5,848,834; 5,167,446; 4,542,447; 5,642,932; 5,363,285; 5,556,003; 5,345,368; 6,023,875; 5,752,633; 5,533,657; and 5,593,074. An additional such flashlight device is disclosed in EP0484891.

In spite of prior work in the area, there remain needs for improved flashlight devices for potential use in conjunction with other hand-held implements such as firearms, particularly in self-defense and/or combat situations, or when performing other tasks or activities that require two handed operation such as those that commonly occur in industrial environments or outdoor activities. There is also a need for a flashlight permitting multi-directional lighting while mounted to the user's hand. The present invention is directed to these needs.

### SUMMARY OF THE INVENTION

A preferred embodiment of the invention is a hand-mountable flashlight which provides hands-free capability by eliminating the need to grasp the device in order to retain it and independently direct a plurality of light sources. These light sources are ergonomically situated to provide multi-directional lighting when the light is mounted on the hand. A first or primary light source produces a more focused and intense light emission as compared to a second light source referred to as the task light. The placement, brightness and beam characteristics of the primary light source provide adequate illumination at distances up to and exceeding 20 feet in a dark environment. The primary light source is designed to provide forward illumination during navigation and clear target identification when the flashlight is used in conjunction with weapons such as a pistol or other firearms. The placement, brightness, and beam characteristics of the task light preferably provide a diffused or less intense light source as compared to the primary light source. The task light is ideal for illuminating objects being held or manipulated by the user or areas that are in proximity to the user's hands. Such objects might include photo identification, hand tools, keyboards, locks and keys, control panels, etc.

The preferred embodiment of the invention includes a handle, a linking member, lamp housing and battery housing. Preferably, the handle is connected to the linking member via a moveable connection and the lamp housing is also connected to the linking member via a moveable connection. When the flashlight is mounted to the hand, the primary light source, which is contained within the lamp housing, is preferably positioned in proximity to the back of the user's hand. The direction of the light emission produced by the primary light source is directionally adjustable via the moveable connections of the lamp housing to the linking member and the handle to the linking member.

Additionally, when the flashlight is mounted to the hand, the task light, which is preferably contained within the linking member, is preferably positioned proximally between the user's index finger and thumb. The area of illumination produced by the task light is proximal to the palm of the user's hand, providing illumination of an object being held by the user or an area in proximity to the hand to which the flashlight is mounted. In the preferred embodiment, the task light is integral to the linking member, however other embodiments could have the task light integral to the handle or be a separate device that could be attached to the linking member or handle and operate independently (with its own controls, power source, etc.) from the flashlight device.

The primary light source and task light together provide an ideal lighting tool for users that require high intensity lighting of objects at a distance up to and exceeding 20 feet and lower intensity diffused lighting for illuminating objects that are being held or are within close proximity of the hand.

In a preferred embodiment, both light sources are controlled by an interface located on the linking member and can be operated simultaneously and/or independently of each other.

Additional preferred embodiments as well as features and advantages of the invention will be apparent from the following descriptions.

### BRIEF DESCRIPTION OF THE SEVERAL VIEWS OF THE DRAWINGS

A better understanding of the present invention can be obtained when the following detailed description of the disclosed embodiments is considered in conjunction with the following drawings, in which:

FIGS. 1 and 2 are perspective views of a preferred embodiment of the flashlight device according to the present invention;

FIG. 3 is a front elevation view of the flashlight device embodiment shown in FIGS. 1 and 2;

FIG. 4 is a view taken along lines 4-4 of FIG. 3;

FIG. 5 is a view taken along lines 5-5 of FIG. 4;

FIG. 6 is a view taken along lines 6-6 of FIG. 3;

FIG. 7 is a side view of the flashlight device of FIGS. 1-3 showing the handle in a pivoted position;

FIG. 8 is a perspective view of the flashlight device of FIG. 7 being used with a first long gun;

FIG. 9 is a perspective view of the flashlight device of FIGS. 1-3 being used with a second long gun;

FIG. 10 is a perspective view of an alternative technique of using the flashlight device in conjunction with a hand gun;

FIG. 11 is a perspective view illustrating the removal or insertion of a firearm's magazine with the flashlight device attached to the user's hand;

FIG. 12 is a perspective view illustrating the operation of a firearm's slide with the flashlight device attached to the user's hand;

FIG. 13 is a perspective view of a preferred embodiment of the flashlight device having a primary light source and a task light;

FIG. 14 is a perspective view of an embodiment of the flashlight device in a tactical position mounted to the user's hand;

FIG. 15 is a perspective view of the preferred embodiment of the flashlight device with task light mounted to the user's hand; and

FIGS. 16 and 17 are perspective views illustrating the incorporation and assembly of the task light in the linking member of the flashlight according to a preferred embodiment of the present invention.

### DESCRIPTION OF THE PREFERRED EMBODIMENTS

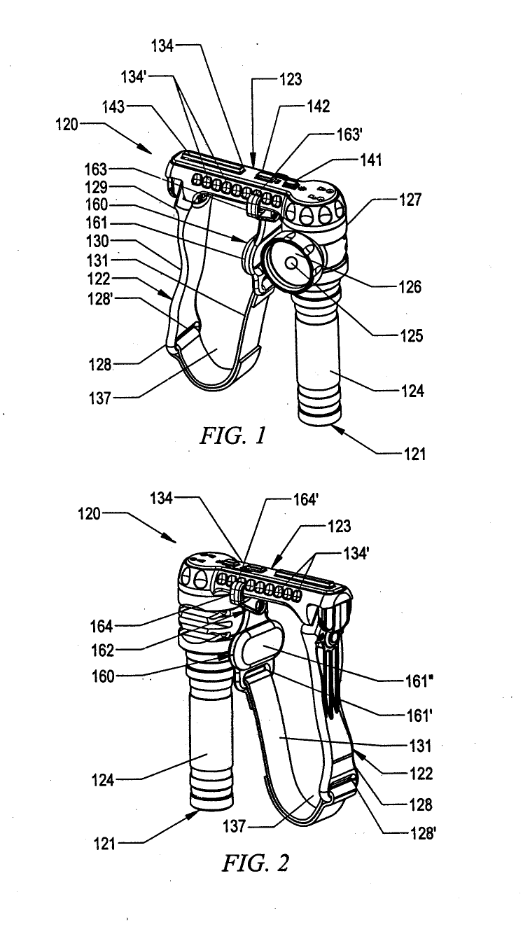

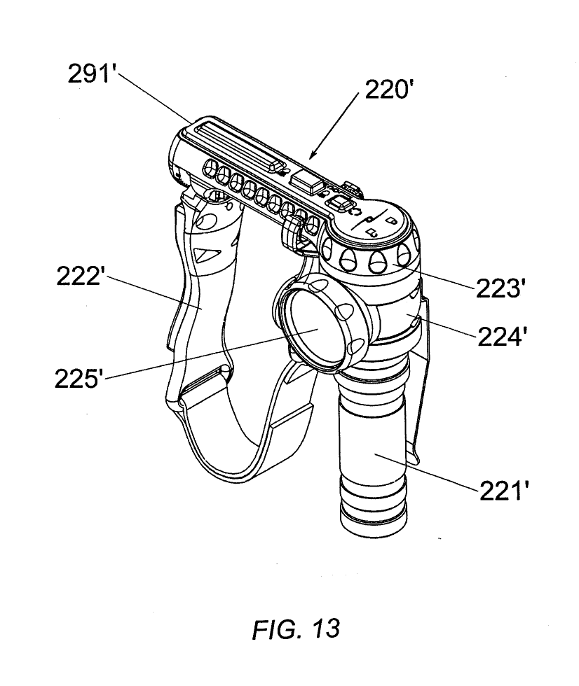

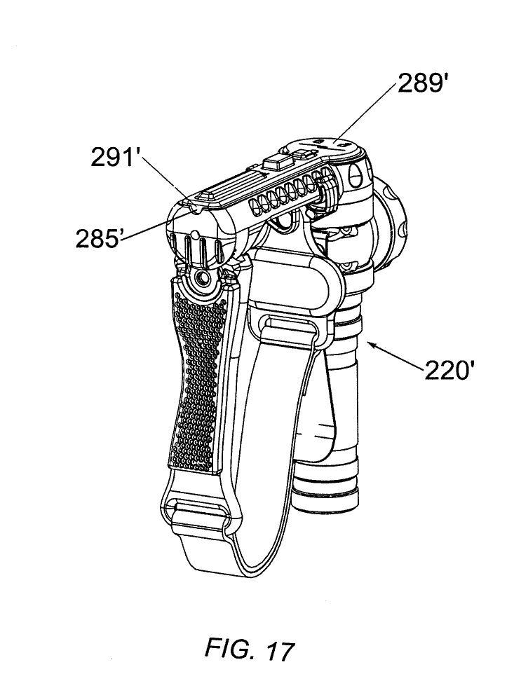

For the purpose of promoting an understanding of the principles of the various embodiments of the present invention, reference will now be made to certain preferred embodiments thereof and specific language will be used to describe the same. It is to be understood that FIGS. 1-12 and the following discussion of FIGS. 1-12 are disclosed in applicant's U.S. Pat. No. 7,303,306, issued Dec. 4, 2007. The preferred embodiment of the present invention of a flashlight device with task light is illustrated in FIGS. 13-17 as a modification of the flashlight device shown in FIGS. 1-12. The features of the flashlight device of FIGS. 1-12 are also present in the preferred embodiment of the present invention of the flashlight device with task light. However, it is to be understood that the present invention is not limited to the embodiments illustrated and described herein, and further that the embodiments illustrated and described comprise applicant's best mode. It will nevertheless be understood that no limitation of the scope of the invention is thereby intended, such alterations, further modifications and applications of the principles of the invention as described herein being contemplated as would normally occur to one skilled in the art to which the invention relates.

As disclosed above, the present invention provides flashlight devices and apparatuses suited for use in two-handed grasping operations or other operations where manual dexterity of the hand holding the flashlight is beneficial, for example in self-defense and/or combat situations, in industrial environments and/or in outdoor recreation.

Referring to FIGS. 1-7, a flashlight device 120 according to one embodiment will now be described. Flashlight device 120 includes a lightbox assembly 121, a handle assembly 122, and a linking member assembly 123 connecting the lightbox assembly 121 and handle assembly 122. Preferably, lightbox assembly 121 includes a generally cylindrical body 124 having mounted therein a light source 125 situated behind a lens 126, preferably formed with a relatively shatterproof plastic material. A first end 127 of the lightbox assembly 121 is preferably rotatably connected to the linking member assembly 123. The connection between the lightbox assembly 121 and the linking member assembly 123 may be accomplished by one of the techniques disclosed in applicant's related U.S. Pat. No. 7,303,306 or by other similar techniques known to persons of skill in the art. Although this connection could be integral, it is preferred that the connection be a movable connection, for example providing for angular rotation about a longitudinal axis of the lightbox assembly 121 so that a user of the flashlight 120 can adjust the direction of the light beam emanating from the light source 125. In the flashlight device 120 as illustrated in FIG. 1, the light source 125 emanates a light beam in a direction generally transverse to the longitudinal axis of the lightbox assembly 121.

Preferably, the handle assembly 122 is likewise movably connected at a handle first end 129 to the linking member assembly 123 by one of the techniques disclosed in applicant's related U.S. Pat. No. 7,303,306 or by other similar techniques known to persons of skill in the art. The linking member assembly 123 includes a linking member 134 having a longitudinal axis. The handle assembly 122 is generally transverse to the longitudinal axis of the linking member 134 and generally pivots about such longitudinal axis.

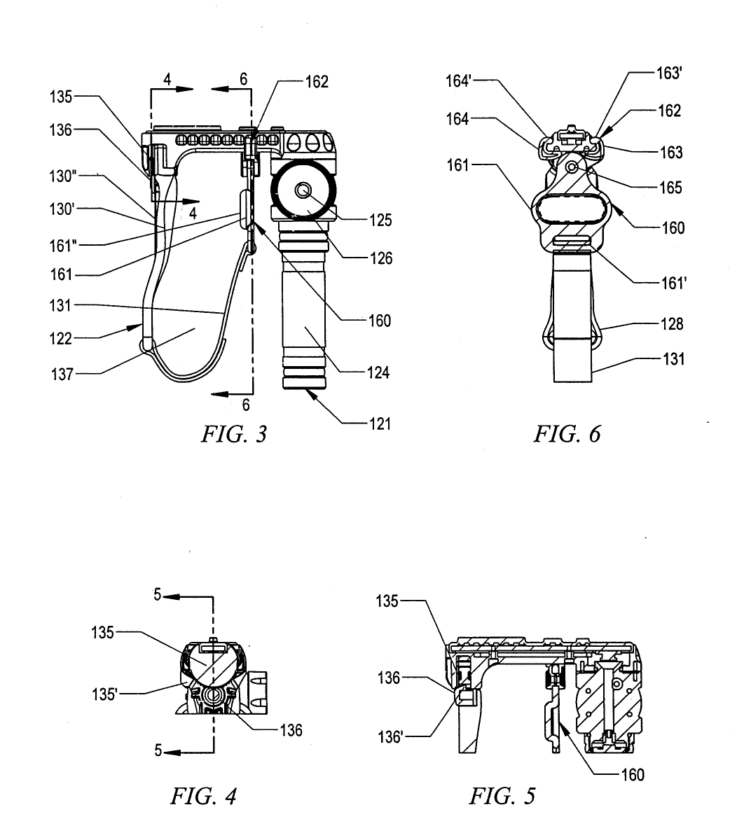

A preferred movable connection between the handle assembly 122 and the linking member assembly 123 is shown in FIGS. 3-5. An indexer gear 135 having a plurality of teeth 135′ is secured to the linking member 134. Preferably, the indexer gear 135 is not allowed to move relative to the linking member 134. The first or upper end 129 of the handle assembly 122 is pivotally connected to the linking member 134. The handle assembly 122 includes a button 136, preferably a spring-biased push button (spring not shown), having gear teeth 136′. As shown in FIG. 5, the gear teeth 136′ are preferably angled from front to back so that they disengage when the button 136 is depressed and re-engage when the button 136 is allowed to spring back.

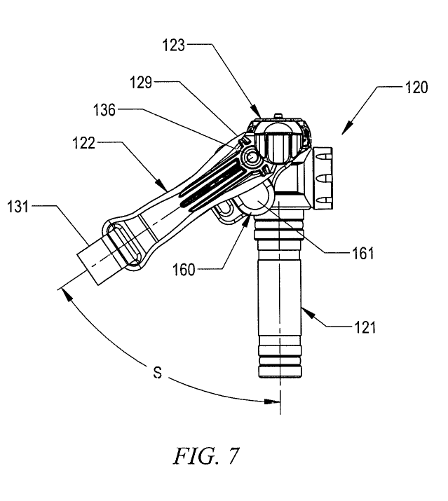

To adjust the angle of the handle assembly 122 relative to the lightbox assembly 121, the user pushes the spring-loaded button 136 which disengages the teeth 136′ on the button 136 from the indexing gear teeth 135′ and the handle assembly 122 is pivoted to the desired position. Once in the desired position the push button 136 is released and the teeth 135′ and 136′ re-engage. This design allows the user to adjust the “sweep” S of the handle 122 as shown in FIG. 7 without tools. Additionally, the user can activate the spring-loaded button 136 with the index finger of the hand that is in the hand receiving opening 137 (FIGS. 1-3) of the flashlight device 120 and grasp the lightbox assembly 121 with the opposite hand to adjust the handle sweep. In the preferred embodiment, the sweep S is in the range of 50° to 60° to either side of the axis of the lightbox assembly 121. Sweeping to both sides allows full use by both left- and right-handed users.

The handle assembly 122 also includes a second end 128 and a central portion 130 spanning between the first and second ends 129 and 128, respectively. Preferably, central portion 130 is ergonomically contoured, as for example with one or more convex or concave sections. In the preferred embodiment as illustrated in FIGS. 1-3, central portion 130 includes an inwardly-facing (toward the lightbox assembly 121) convex portion 130′ (FIG. 3) adapted to ergonomically cooperate with the palm of the hand in a firing position of a handgun. Additionally, the central portion 130 preferably includes an outwardly-facing (away from the lightbox assembly 121) generally concave portion 130″ adapted to provide a clearance between the central portion 130 of the handle assembly 122 and the firearm when held in the two-handed firing position. The concave portion 130″ provides a clearance so that the handle assembly 122 does not accidentally come into contact with a firearm's magazine release button located on an automatic firearm's side opposite the firing hand. If desired, handle assembly 122 can be covered with or made of a material with a relatively high coefficient of friction to improve gripping properties.

Preferably, the second end 128 of the handle assembly 122 is adapted to attach a strap 131 thereto with the strap 131 extending toward the linking member assembly 123. In the illustrated embodiment, a slot 128′ is provided in the second end 128 of the handle assembly 122 for securing the strap 131 to the handle assembly 122. Preferably, the strap 131 is also secured to a hand stabilizer assembly 160 connected to the linking member assembly 123 to define a hand receiving opening 137. Referring to FIGS. 1-3 and 6, the hand stabilizer assembly 160 preferably includes a hand pad 161 connected to the linking member 134 via a clip assembly 162. The strap 131 is attached to the hand pad 161, preferably via a slot 161′. The clip assembly 162 preferably includes first and second hook members 163 and 164, respectively, connected to each other via a fastener 165, such as a pin or rivet 165 (FIG. 6). The hand pad 161 is preferably pivotally connected to the clip assembly 162. In the preferred embodiment, the hand pad 161 is pivotally connected to the clip assembly 162 via the pin 165 and the strap 131 is connected to the hand pad 161 via a slot 161A. The pin 165 allows the hand pad 161 to swivel independently from the clip assembly 162. Thus, as the handle assembly 122 is pivoted relative to the linking member assembly 123, the strap 131 “pulls” on the hand pad 161 to similarly pivot the hand pad 161 as shown in FIG. 7. This feature of maintaining the hand pad 161 substantially in line with the strap 131 and handle assembly 122 maintains the maximum amount of surface area of the strap 131 contacting the user's hand during use regardless of the pivoted position of the handle assembly 122. Preferably, the strap 131 is adjustable in length to accommodate various sizes of hands.

Referring to FIGS. 2 and 3, a plurality of recesses 134′ are formed in the linking member 134. The recesses 134′ are preferably uniformly spaced along a portion of the length of the linking member 134 and in pairs positioned on opposite sides of the linking member 134. Each recess 134′ is adapted to receive an end portion 163′ and 164′ of the hook members 163 and 164, respectively. The hand pad 161 includes a surface 161″ facing the handle assembly 122 adapted to contact the back of the user's hand. Preferably, during one operation of use the palm of the user's hand is against the inside surface or convex portion 130′ of the handle assembly 122 and the back of the hand is against the hand pad surface 161″. Preferably, the user's hand is snugly received in the hand receiving opening 137 between the handle assembly 122 and the hand pad 161 to stabilize the flashlight 120 on the hand without the necessity of grasping the handle assembly 122 or other portion of the flashlight 120. The desired spacing between the hand pad surface 161″ and the opposing surface of the handle assembly 122 is achieved by placing the hook end portions 163′ and 164′ in the appropriate recesses 134′ for the desired spacing.

Preferably, the spacing between the handle assembly 122 and the hand pad 161 is easily adjustable without the need for tools. In the illustrated embodiment, the location of the hand pad 161 can be adjusted by disengaging the hook end portions 163′ and 164′ from the recesses 134′ and re-engaging the hook end portions 163′ and 164′ in the desired recesses 134′. Depending on the type of material that the clip assembly 162 is made out of, the hook end portions 163′ and 164′ may be forcibly disengaged and re-engaged in the recesses 134′. Alternatively, the clip assembly 162 could be made such that the hook end portions 163′ and 164′ can be disengaged from a pair of recesses 134′ by moving the pin connection of the clip assembly 162 towards the linking member 134 to slightly raise and spread the hook end portions 163′ and 164′ out of engagement with the pair of recesses 134′, thus permitting sufficient clearance to slide the clip assembly 162 along the linking member 134 to the desired pair of recesses 134′.

The preferred construction of the hand stabilizer assembly 160 allows the hook members 163, 164 to increase the gripping force exerted on the linking member 134 when downward or pulling pressure is applied to the hand pad 161, as for example by tightening the strap 131. In addition, the stabilizer assembly 160 rigidifies the strap 131 itself to eliminate the tendency for the flashlight 120 to inadvertently move or slip on the user's hand when the hand is opened and moved in an abrupt way.

Preferably, the strap 131 is connected at one end to the hand pad 161 and at the other end to the handle slot 128′, which allows the strap 131 to be doubled back and secured to itself using a hook and loop fastener, for example a Velcro fastener. The combination of the handle assembly 122, the linking member 134, the hand stabilizer assembly 160 and the strap 131 define the hand receiving opening 137 through which the user's hand can be placed while using the flashlight 120. Preferably, the strap 131 can be disconnected from the hand pad 161 and from the handle slot 128′ to remove it from the flashlight device 120. If desired, the hand stabilizer assembly 160 can be removed from the device 120. For example, removal of the hand stabilizer assembly 160 can be accomplished by forcibly prying the hook members 163 and 164 from the linking member 134. This enables the user to operate the flashlight 120 with a large glove that would require more room for the hand than the hand stabilizer assembly 160 allows. Other users may prefer not to “fix” the flashlight 120 to the hand and this removal option allows for this as well.

In the preferred embodiment as shown in FIGS. 1 and 2, the flashlight device 120 includes one or more switches for controlling various lighting features. With reference to FIG. 1, a power switch 141, an on/off switch 142 and a momentary “on” switch 143 are preferably located on the linking member 134. Preferably, the momentary “on” switch 143 is an elongated switch located adjacent or in proximity to the outer edge of the linking member 123 overlying the outer edge of handle assembly 122 to provide convenient access for operation during various firing positions, including a two-handed combat position and positions used in firing long guns as described below, or other manual hand activities. Preferably, switch 143 is a pressure-sensitive switch functional to energize the light source 125 upon the exertion of pressure, but without locking or fixing the switch in the “on” position. In this fashion, the user of the flashlight device 120 can more readily briefly energize, and then de-energize the light source 125 to fix the position of an article or person, but without continued illumination.

On/off switch 142 is preferably a switch having a fixed “on” condition that is achieved by exerting a predetermined level of pressure on the switch 142. In the “on” condition, the light source 125 is constantly illuminated until the switch 142 is again depressed to change the switch to the “off” condition.

Preferably, the power switch 141 is a multi-stage switch to adjust lamp brightness. For example, the power switch 141 may be a three-way switch to provide three levels of lamp brightness.

Preferably, a “lockout” is provided to ensure that the on/off switch 142 or the momentary “on” switch 143 are not inadvertently “on” while the flashlight device 120 is stored such that the batteries are dead when the flashlight device 120 is needed by the user. In an embodiment of the invention, the lockout is activated by simultaneously depressing the power switch 141 and the constant on/off switch 142 and may be released in a similar manner. In the lockout condition, the light source 125 cannot be powered by either of the switches 142 and 143 being pressed to their “on” condition. This ensures that the flashlight device 120 is not inadvertently on while stored and is ready for use when needed by the user.

Long-Gun Application

Currently law enforcement and military personnel use gun-mounted flashlights for use on long guns, such as rifles and shotguns, in tactical environments. These flashlights are often attached to a ring retainer that is then attached to a Picatinny rail mount system on the long gun itself. Some of these lights are fixed with screws, others are attached to the rail using “quick release” mechanisms, while other lights are attached using a ring retainer that is attached to the barrel of the weapon. Many of these lights are regular flashlights with a “pigtail” switch in an optional tailcap, which replaces the stock tailcap.

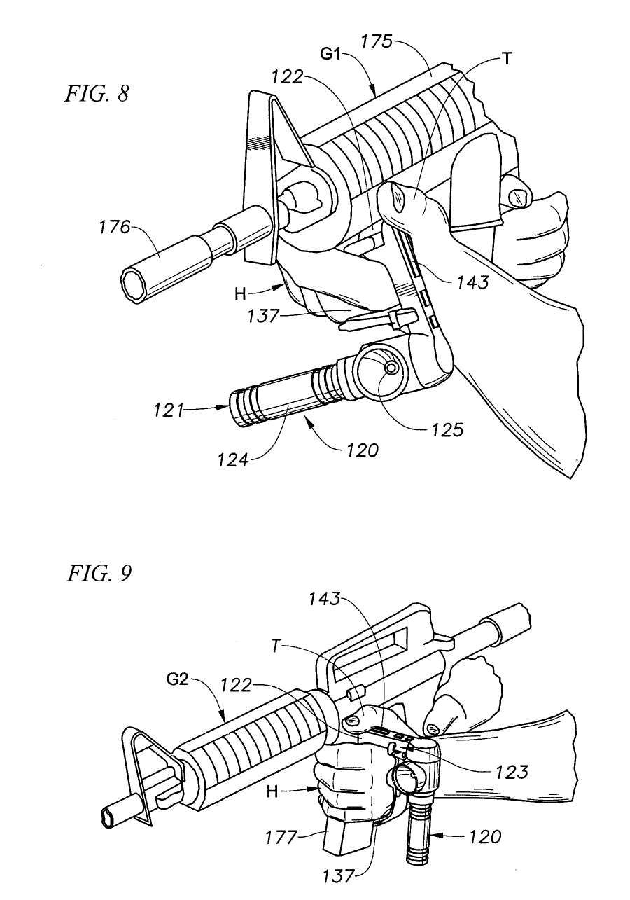

Although a preferred embodiment of the invention has been described above and in applicant's U.S. Pat. No. 7,303,306 for use in a tactical position with a handgun, the various embodiments of the flashlight device according to the present invention can also be used with long guns, including rifles and shotguns. The following description will be with respect to the flashlight device 120 although it is to be understood that the flashlight device with task light 120′ (described below) and other embodiments are also adapted for such use. FIGS. 8 and 9 show the flashlight device 120 being used in two positions with long guns G1 and G2, respectively.

In FIG. 8, the long gun G1 is held by grasping the “horizontal” forearm 175 of the long gun G1. Preferably, the user sweeps the handle 122 (see FIG. 7) to a position such that when the forearm 175 of the weapon is grasped in the typical manner, the light source 125 is substantially in-line with the barrel 176 of the gun G1. With the user's non-shooting hand H in the hand receiving opening 137, the user grasps the “horizontal” forearm 175 of the weapon G1 as shown in FIG. 8. In this method the forearm 175 of the weapon G1 preferably “rests” on or contacts the handle 122 of the flashlight device 120 and the switch 143 is readily accessible by the thumb T of the non-shooting hand H to emit a light beam toward the target. Typically, the handle 122 is not swept to a position perpendicular to the light housing 124 as one might assume, but rather is swept to a position that allows it to fit comfortably into the palm of the hand H when the forearm 175 of the weapon G1 is grasped.

In addition to the user being able to position the flashlight device 120 to shine forward while grasping the standard “horizontal” forearm 175 of the long gun G1, the flashlight device 120 can also be used when grasping either a “vertical” forearm or an ammunition magazine 177 of the long gun G2, as shown in FIG. 9. A vertical forearm 177 is often added as an accessory to the long gun weapon G2. It is to be understood that the flashlight device of the present invention can be used with either a vertical forearm or ammunition magazine. Referring to FIG. 9, with the user's non-shooting hand H in the hand receiving opening 137, the user grasps the ammunition magazine 177 with the handle 122 resting against the magazine 177. Preferably, the user wraps all fingers around the vertical magazine 177 except for the thumb T which is positioned above the linking member assembly 123 to activate the switches, typically the momentary switch 143.

Oftentimes when conducting a building search, users will transition from a rifle to a handgun depending on the situation. The flashlight device of the present invention allows the user great flexibility when transitioning between weapons. Since the flashlight device attaches to the hand and not to the gun, no removal of the flashlight device from the gun is required. Furthermore, since the flashlight neither attaches to the gun or requires any modifications to the gun, the first gun can be quickly holstered in its typical manner and the second gun immediately picked up.

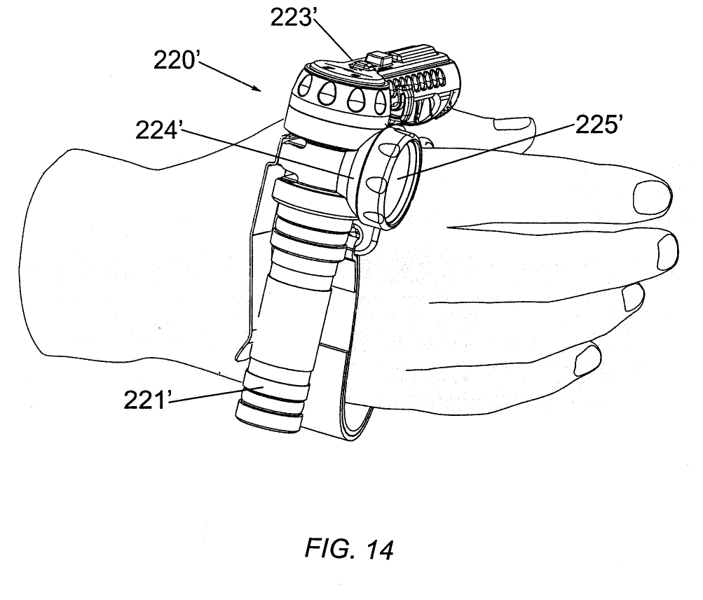

The flashlight device of the present invention is extremely versatile and quickly and easily transitions between the tactical position (lightbox assembly 121 opposite the palm, behind the hand; see FIG. 14) when using a handgun and the tactical position used with the long guns—whether grasping the long gun horizontally or vertically—and vice versa. Depending on the guns and the user, it may be necessary or desirable to adjust the “sweep” or angle of the handle 122 relative to the lightbox assembly 121. This is done quickly by pushing in the button 136 and pivoting the handle 122 to the desired angle—without the use of any tools. Typically, the direction of the light source 125 relative to the linking member 123 remains unchanged and requires no adjustment. Even if adjustment is required, it is very quickly and easily accomplished.

Additional benefits not to be overlooked are that the flashlight device does not require any mounting or attachment devices to be added to the gun(s). As a result, the guns can be holstered in their typical manner. Also, by having the flashlight device independent from (not mounted or attached to) the weapon, it allows the user to illuminate in directions independent of the direction the weapon is being pointed—an added safety feature when illuminating human subjects.

Better Shooting in any Lightbox Assembly Position

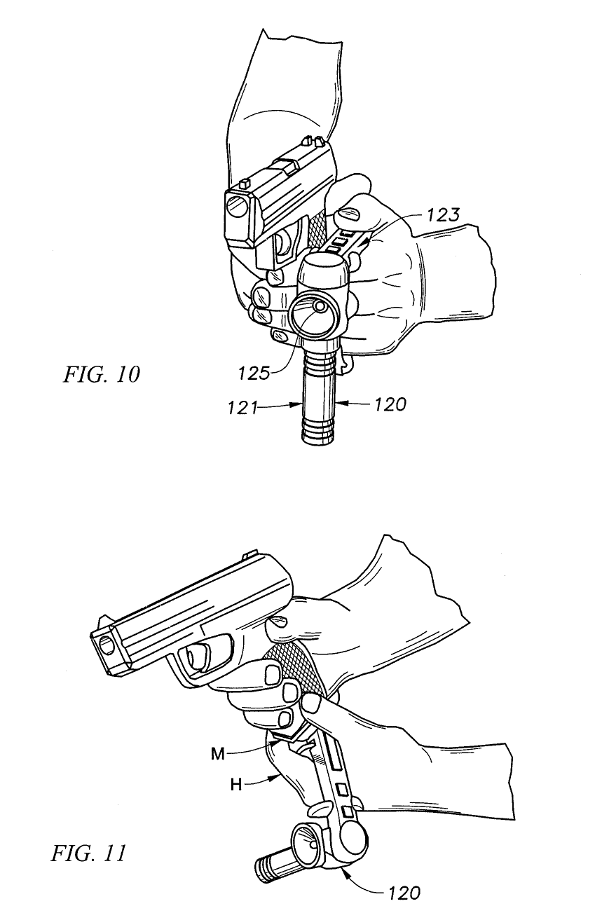

As described above and shown in FIGS. 8 and 9, the user benefits significantly while shooting with the flashlight device of the present invention in the tactical position. Further benefits are described and illustrated with specific reference to FIGS. 3 and 6 of applicant's U.S. Pat. No. 7,303,306. However, users will also find the design to be beneficial when shooting with the flashlight device 120 in the utility position (light source 125 oriented in substantial alignment with the linking member 123) as shown in FIG. 10. In certain circumstances, the user may need to quickly access the flashlight device 120 to illuminate a target with the flashlight device in the utility position and the technique shown in FIG. 10 may be preferred.

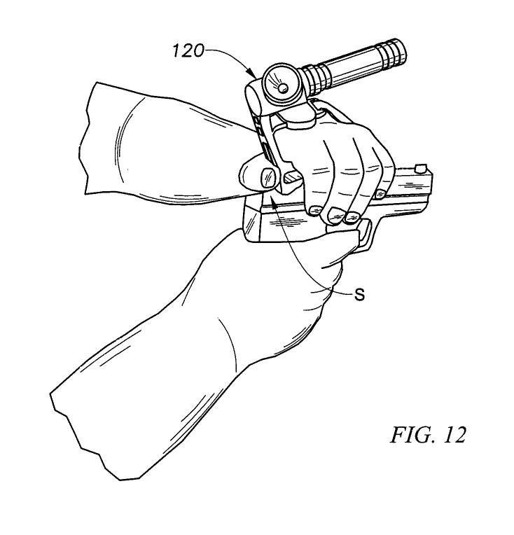

FIGS. 11 and 12 show some basic gun handling maneuvers and how the flashlight device according to the preferred embodiment of the present invention does not inhibit such maneuvers. With the flashlight device 120 attached to the user's non-shooting hand H, FIG. 11 illustrates the removal or insertion of a firearm's magazine M and FIG. 12 illustrates the operation of a firearm's slide S. It is vitally important to the user to be able to do such maneuvers quickly and easily and without interference by the flashlight device 120.

FIGS. 13-17 will now be referred to while discussing the preferred embodiment of the flashlight with task light, generally referred to as 220′, having a primary light source 225′ and a task light 285′. For purpose of illustration, the flashlight 220′ with task light 285′ is shown as a modified version of the flashlight 120 of FIGS. 1-7. It is to be understood that the flashlight with task light embodiment of the present invention is not limited to the preferred embodiment illustrated in FIGS. 13-17, but may comprise other structural configurations as would be understood by those of ordinary skill in the art.

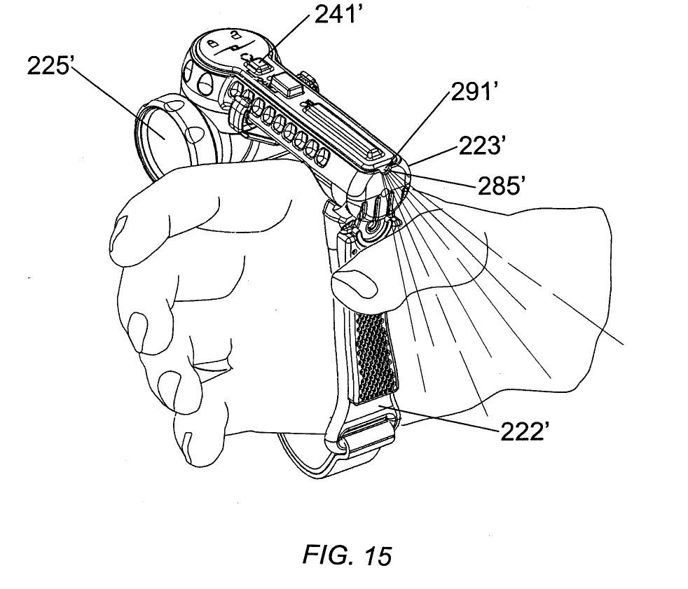

The preferred embodiment of the invention is a hand-mountable flashlight 220′ which provides hands-free capability by eliminating the need to grasp the device in order to retain it and independently direct a plurality of light sources as shown FIGS. 14 and 15. These light sources are ergonomically situated to provide multi-directional lighting when the flashlight 220′ is mounted on the hand. The first or primary light source 225′ produces a more focused and intense light emission as compared to the second light source referred to as the task light 285′. Preferably, the placement, brightness and beam characteristics of the primary light source 225′ provide adequate illumination at distances up to and exceeding 20 feet in a dark environment. The primary light source 225′ is designed to provide forward illumination during navigation and clear target identification when the flashlight 220′ is used in conjunction with weapons such as a pistol or other firearms.

The placement, brightness, and beam characteristics of the task light 285′ preferably provide a diffused or less intense light source as compared to the primary light source 225′. The task light 285′ is ideal for illuminating objects being held or manipulated by the user, or areas that are in proximity to the user's hands. Such objects might include photo identification, hand tools, keyboards, locks and keys, control panels, etc.

The preferred embodiment of the flashlight 220′ includes a handle 222′, a linking member 223′, lamp housing 224′ and battery housing 221′ as shown in FIG. 13. Preferably, the handle 222′ is connected to the linking member 223′ via a moveable connection and the lamp housing 224′ is also connected to the linking member 223′ via a moveable connection. When the flashlight 220′ is mounted to the hand, the primary light source 225′, which is contained within the lamp housing 224′, is preferably positioned in proximity to the back of the user's hand as shown in FIGS. 14 and 15. The direction of the light emission produced by the primary light source 225′ is directionally adjustable via the moveable connections of the lamp housing 224′ to the linking member 223′ and the handle 222′ to the linking member 223′.

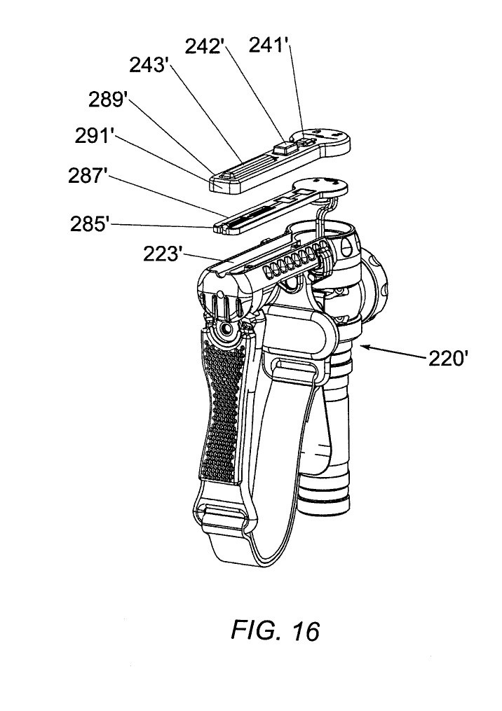

Additionally, when the flashlight 220′ is mounted to the hand, the task light 285′, which is preferably contained within the linking member 223′, is preferably positioned proximally between the user's index finger and thumb. As shown in FIG. 15, the area of illumination produced by the task light 285′ is proximal to the palm of the user's hand, providing illumination of an object being held by the user or an area in proximity to the hand to which the flashlight 220′ is mounted. In the preferred embodiment, the task light 285′ is integral to the linking member 223′, however other embodiments could have the task light 285′ integral to the handle 222′ or be a separate device that could be attached to the linking member 223′ or handle 222′ and operate independently (with its own controls, power source, etc.) from the flashlight device. Referring to FIG. 16, the task light 285′ is preferably mounted to a circuit board or control panel 287′ nested in the linking member 223′ below a panel overlay 289′. Preferably, a window or lens 291′ is incorporated in the end of the panel overlay 289′ to allow light from the task light 285′ to pass upon illumination. In a preferred embodiment, the control panel 287′ is preferably a multi-function control panel capable of providing signals to control and implement the required lighting functions upon manipulation of the switches or controls 241′, 242′ and 243′. The switches 241′, 242′ and 243′ preferably function as the switches 141, 142 and 143 described above with the following modification. When the primary light source 225′ is off, switch 241′ is used to control turning the task light 285′ on and off.

The primary light source 225′ and task light 285′ together provide an ideal lighting tool for users that require high intensity lighting of objects at a distance up to and exceeding 20 feet and lower intensity diffused lighting for illuminating objects that are being held or are within close proximity of the hand.

In the preferred embodiment, both light sources 225′, 285′ are controlled by the switching interface located on the linking member 223′ and can be operated simultaneously and independently of each other.

The flashlight device of the present invention provides the user with multiple ergonomic and tactical advantages when used to perform routine activities and in combination with a firearm. These advantages include:
Ability to use hands freely to manipulate objects;
Multi-directional lighting capabilities with primary light source and task light;
Faster target acquisition and superior illumination;
Improved accuracy when firing a weapon in low light situations;
Improved stability on firearm recoil;
Fingers remain free to provide the correct two-handed grip on the weapon or to perform other actions such as accessing spare clips, radios, or handcuffs;
Light housing rotates to provide right, left, and forward lighting positions;
Ambidextrous design and ergonomic grip accommodates all users regardless of hand preference or size; and
Overall ergonomic superiority compared to conventional flashlight designs.

While the invention has been described in detail above with reference to specific embodiments, it will be understood that modifications and alterations in the embodiments disclosed may be made by those practiced in the art without departing from the spirit and scope of the invention. All such modifications and alterations are intended to be covered. In addition, all publications cited herein are indicative of the level of skill in the art and are hereby incorporated by reference in their entirety as if each had been individually incorporated by reference and fully set forth.

We claim:

1. A flashlight apparatus comprising:
a lightbox having a battery housing and a lamp housing, said lamp housing including a primary light source for emitting a directional light beam during use;
a linking member having a first end coupled to said lightbox;
a handle coupled to a second end of said linking member; and
said linking member having a task light for emitting a task light beam at said second end of said linking member.

2. The flashlight apparatus of claim 1, wherein said linking member further comprises controls for said primary light source and said task light.

3. The flashlight apparatus of claim 1, wherein said task light is adapted to direct the task light beam in a direction substantially opposite of said primary light source.

4. The flashlight apparatus of claim 1, wherein said task light is adapted to direct the task light beam in a direction substantially opposite of the directional light beam of said primary light source.

5. The flashlight apparatus of claim 1, wherein said primary light source is directionally adjustable through approximately 180 degrees of rotation.

6. The flashlight apparatus of claim 1, wherein said task light is adapted to direct the task light beam in a direction substantially 90 degrees from the direction of said primary light source.

7. The flashlight apparatus of claim 1, wherein said task light is adapted to direct the task light beam in a direction in the range of approximately 90 degrees to 180 degrees from the direction of said primary light source.

8. A flashlight apparatus comprising:
an assembly comprising a battery housing for containing a battery, a lamp housing including a primary light source adapted for emitting a directional light beam, and a secondary light source adapted for emitting a secondary light beam in a direction other than in the direction of said directional light beam of said primary light source.
